(19) United States
(12) Patent Application Publication
(10) Pub. No.: US 2026/0066298 A1
(43) Pub. Date: Mar. 5, 2026

(54) METHOD FOR MANUFACTURING METAL-ORGANIC FRAMEWORK, METAL-ORGANIC FRAMEWORK, AND ALL-SOLID-STATE BATTERY ANODE INCLUDING THE SAME

(71) Applicants: HYUNDAI MOTOR COMPANY, Seoul (KR); KIA CORPORATION, Seoul (KR); UIF (University Industry Foundation)., Seoul (KR)

(72) Inventors: Ki Yoon Bae, Hwaseong-si (KR); Sang Heon Lee, Hwaseong-si (KR); Sam Ick Son, Hwaseong-si (KR); Ji Young Kim, Hwaseong-si (KR); Jong Hyeok Park, Seoul (KR); Min Je Ryu, Seoul (KR)

(21) Appl. No.: 19/076,808

(22) Filed: Mar. 11, 2025

(30) Foreign Application Priority Data
Sep. 3, 2024 (KR) 10-2024-0119467

(51) Int. Cl. H01M 4/60; H01M 4/04

(52) U.S. Cl. CPC H01M 4/60; H01M 4/0497

(57) ABSTRACT

A method for manufacturing a metal-organic framework, a metal-organic framework manufactured therefrom, and an all-solid-state battery anode including the metal-organic framework are provided. The method includes preparing a precursor solution by introducing a basic additive into a mixed solution including a Co precursor and an organic ligand (S1), introducing an Ni precursor into the precursor solution and obtaining a precipitate (S2), and obtaining the metal-organic framework by cleaning and drying the precipitate (S3).

### CROSS-REFERENCE TO RELATED APPLICATION

This application claims the benefit of priority to Korean Patent Application No. 10-2024-0119467, filed in the Korean Intellectual Property Office on Sep. 3, 2024, the entire contents of which are incorporated herein by reference.

### TECHNICAL FIELD

The present disclosure relates to a method for manufacturing a metal-organic framework, capable of exhibiting stable charging/discharging performance and capacity retention rate, when incorporated in an anode. The disclosure also provides a metal-organic framework manufactured by the described method, and an all-solid-state battery anode including the metal-organic framework.

### BACKGROUND

An all-solid-state battery, which is a next generation technology of storing energy developed to overcome the disadvantages of a lithium ion battery, employs a solid electrolyte instead of a liquid electrolyte. The all-solid-state battery provides a higher energy density, stability, and a longer lifespan. As such, the all-solid-state battery technology has been drawn to higher-performance application fields such as, for example, electric vehicles. To maximize the performance of the all-solid-state battery, various electrode materials have been studied. Among them, metal-organic framework (MOF) materials have been evaluated.

Conventional metal-organic framework material is typically prepared using only one metal ion. When a single metal ion metal-organic framework is used in an all-solid-state battery system, the metal-organic framework typically shows a lower initial coulombic efficiency, is rapidly reduced in an available capacity after an initial cycle, and can lose contact area with the solid electrolyte. Accordingly, the metal-organic framework is degraded in electron and ion transfer efficiency.

A dual-ion metal-organic framework material employing two metal ions has been explored in an effort to address the shortcomings of the single metal ion technology. However, using a conventional one-pot mixing scheme has been limited in achieving any improvement or synergistic effect between the dual metal ions and organic ligand, because including two metal ions makes the reaction path for binding metal to organic ligand difficult to control. In addition, known methods lead to an unpredictable mixed metal-organic ligand framework structure and/or phase separation. Because existing technology fails to (i) adequately control for predictable structures, (ii) avoid unpredictable by-products, and/or (iii) avoid competitive reactivity between the different metal ions, there is a need for improved methods for synthesizing a metal-organic framework that can reliably optimize the interaction between metal ions and a ligand in a metal-organic framework material in order to maximize the battery performance.

### SUMMARY

The present disclosure solves the above-mentioned problems associated with the state of the art, while maintaining advantages that have been achieved by the technology.

An aspect of the present disclosure provides a method for manufacturing a metal-organic framework, capable of exhibiting one or more of stable charging/discharging performance, stable capacity retention rate, and/or an excellent coulombic efficiency, for example, when used in all-solid-state battery anode, as a metal-organic framework manufactured through the manufacturing method, and as an all-solid-state battery anode including the metal-organic framework.

In some embodiments, a double-ion metal-organic framework is synthesized by using a Co ion, which can provide stable battery performance and stable capacity retention rate, and a Ni ion which can, together, provide for an effective initial coulombic efficiency. In embodiments, the Co ion, which is more stable and has a larger ion size relative to Ni, is first synthesized to provide a structure having improved and/or optimized electron transfer and reduction reaction in combination with a lithium ion.

The technical problems to be solved by the present disclosure are not limited to the aforementioned problems, and solutions to any other technical problems not mentioned herein will be clearly understood from the following description by those skilled in the art to which the present disclosure pertains.

In a general sense, the present disclosure provides a method for manufacturing a metal-organic framework, a metal-organic framework generated by the method, and an all-solid-state battery anode comprising the same.

In some embodiments, (1) the present disclosure provides a method for manufacturing a metal-organic framework, that comprises: preparing a precursor solution by introducing a basic additive into a mixed solution comprising a Co precursor and an organic ligand (S1), introducing an Ni precursor into the precursor solution under conditions sufficient to generate a precipitate (S2), and obtaining the metal-organic framework by isolating (e.g., cleaning and drying) the precipitate (S3). In some embodiments of the method, the amount of Co precursor (e.g., the number of moles of Co precursor) used in the method is larger than the amount of the Ni precursor (e.g., the number of moles of Ni precursor).

(2) In further embodiments, the present disclosure provides a method for manufacturing a metal-organic framework, that further comprises processing (e.g., mixing) the precursor solution by using ultrasonic wave energy after introducing the Ni precursor in S2, in embodiment (1).

(3) In further embodiments, the present disclosure provides a method for manufacturing a metal-organic framework, in which the Co ions from the Co precursor and the Ni ions from the Ni precursor comprise a mole ratio that ranging from greater than 1:1 and less than or equal to 10:1 in embodiments (1) or (2).

(4) In further embodiments, the present disclosure provides a method for manufacturing a metal-organic framework, in which a mole ratio between the Co precursor and the organic ligand ranges from equal to or greater than 100:90 and equal to or less than 100:110, in any one of embodiments (1) to (3).

(5) In further embodiments, the present disclosure provides a method for manufacturing a metal-organic framework, in which the organic ligand comprises at least one of 2,5-thiophenedicarboxylic acid, 2-nitro-1,4-benzenedicarboxylic acid, triphenylamine, 2,2′-bipyridine, and/or 1,10-phenanthroline, in any one of embodiments (1) to (4).

(6) In further embodiments, the present disclosure provides a method for manufacturing a metal-organic framework, in which the basic additive comprises at least one of triethylamine, dimethylamine, pyridine, trimethylamine, isopropylamine, triethanolamine and/or methylamine in any one of embodiments (1) to (5).

(7) In further embodiments, the present disclosure provides a method for manufacturing a metal-organic framework, in which the Co precursor comprises at least one of CoCl₂·6H₂O, CoSO₄·6H₂O, Co(NO₃)₂·6H₂O, Co(C₂H₃O₂)₂·4H₂O, and/or CoC₂O₄·2H₂O, and in some preferred embodiments, may include CoCl2·6H₂O, in any one of embodiments (1) to (6).

(8) In further embodiments, the present disclosure provides a method for manufacturing a metal-organic framework, in which the Ni precursor comprises at least one of NiCl₂·6H₂O, NiSO₄·6H₂O, Ni(NO₃)₂·6H₂O, Ni(C₂H₃O₂)₂·4H₂O and/or NiC₂O₄·2H₂O in any one of embodiments (1) to (7).

(9) In further embodiments, the present disclosure provides a method for manufacturing a metal-organic framework, in which the metal-organic framework comprises a core structure comprising a Co ion and an organic ligand, and a surface structure comprising a Ni ion and an organic ligand, in any one of embodiments (1) to (8).

(10) In further embodiments, the present disclosure provides a metal-organic framework including a core structure comprising a Co ion and an organic ligand, and a surface structure comprising a Ni ion and an organic ligand, in which the number of moles of Co ions is larger than the number of moles of Ni ions.

(11) In further embodiments, the present disclosure provides a metal-organic framework in which the organic ligand comprises at least one of 2,5-thiophenedicarboxylic acid, 2-nitro-1,4-benzenedicarboxylic acid, triphenylamine, 2,2′-bipyridine, and/or 1,10-phenanthroline, in embodiment (10).

(12) In further embodiments, the present disclosure provides a metal-organic framework in which a mole ratio between the Co ion and the Ni ion ranges from greater than 1:1 and less than or equal to 10:1, in embodiments (10) or (11).

(13) In further embodiments, the present disclosure provides an all-solid-state battery anode including a metal-organic framework according to any one of embodiments (10) to (12).

(14) In further embodiments, the present disclosure provides an all-solid-state battery including an anode according to embodiment (13).

### BRIEF DESCRIPTION OF THE DRAWINGS

The above and other aspects, objects, embodiments, features and advantages of the present disclosure will be more apparent from the following detailed description taken in conjunction with the accompanying drawings:

FIG. 1 illustrates the analysis result of Transmission Electron Microscopy Energy Dispersive X-ray Spectroscopy (TEM EDS) that determine the distribution of Co ions and Ni ions in a metal-organic framework manufactured according to an embodiment of the present disclosure;

FIGS. 2A and 2B are views illustrating the capacity changes depending on the number of charge and discharge cycles of an all-solid-state battery anode including metal-organic frameworks manufactured according to an embodiment of the present disclosure and a comparative example;

FIG. 3A is a view illustrating an analysis result of scanning electron microscopy energy dispersive X-ray spectroscopy (SEM EDS) to determine the distribution of Co ions and Ni ions of a metal-organic framework manufactured according to an embodiment of the present disclosure; and

FIG. 3B is a view illustrating an analysis result of TEM EDS to determine the distribution of Co ions and Ni ions of a metal-organic framework manufactured according to an embodiment of the present disclosure.

### DETAILED DESCRIPTION

Hereinafter, the present disclosure will be described in more detail.

The terminology or words used in the present specification and the claims shall not necessarily be interpreted as commonly-used dictionary meanings, but should be interpreted based on the technical scope of the present disclosure. Unless specifically defined herein, all terms should be understood to have their common and ordinary meanings as used in the relevant art, unless otherwise stated or defined by the inventors to best explain the present disclosure.

### Method for Manufacturing Metal-Organic Framework

The present disclosure provides a method for manufacturing a metal-organic framework, which includes preparing a precursor solution by adding a basic additive to a mixed solution comprising a cobalt (Co) precursor and an organic ligand (S1), adding a nickel (Ni) precursor to the precursor solution to generate a precipitate, (S2), and washing and drying the precipitate to obtain the metal-organic framework (S3). In embodiments, the amount (e.g., number of moles) of Co precursor used is larger than the amount (e.g., number of moles) of Ni precursor.

Hereinafter, embodiments of the manufacturing method of the present disclosure will be described in further illustrative detail.

### Preparing of Co Precursor Solution (S1)

According to some embodiments, the method for manufacturing the metal-organic framework of the present disclosure comprises, ‘S1’ which refers to a step for preparing a precursor solution that comprises introducing a basic additive into a mixed solution comprising a Co precursor and an organic ligand.

According to embodiments of the present disclosure, the mixed solution may be obtained by introducing the Co precursor and the organic ligand into a solvent that comprises at least one of dimethyl sulfoxide (DMSO), N,N-dimethylformamide (DMF), N,N-diethylformamide (DEF), water, methanol, ethanol, isopropyl alcohol, dimethylacetamide (DMA), ethylene glycol (EG), acetonitrile (ACN), ethylene carbonate (EC), propylene carbonate (PC), dimethyl carbonate (DMC), diethyl carbonate (DEC), ethylmethyl carbonate (EMC), 1,2-dimethoxyethane (DME), γ-buthrolactone (GBL), methyl formate (MF), and methyl propionate (MP).

The Co precursor used to prepare the mixed solution according to embodiments of the present disclosure may form a structural feature in the metal-organic framework generated by the method, and which can adjust at least one electronic characteristic, and which may also provide one or both of an optical characteristic and a magnetic characteristic. In particular embodiments, a Co ion (provided by the Co precursor) has a high energy density and excellent electrochemical performance and shows good mechanical strength. Accordingly, some embodiments falling within the scope of the disclosure that comprise Co ions as a component in the all-solid-state battery, provide an all-solid-state battery that may achieve favorable and/or improvements in stable charging/discharging performance and capacity retention rate.

In some embodiments, the Co precursor may include at least one of CoCl₂·6H₂O, CoSO₄·6H₂O, Co(NO₃)₂·6H₂O, Co(C₂H₃O₂)₂·4H₂O and/or CoC₂O₄·2H₂O, and in some preferred embodiments, may include CoCl₂·6H₂O.

According to embodiments of the present disclosure, the organic ligand used in preparing the mixed solution binds to a metal ion to form a three-dimensional structure comprising the metal-organic framework. Accordingly, the characteristic of the structure, the length, and the functional group of the organic ligand may exert an influence on the geometrical structure and the porosity (size of air pores) of the metal-organic framework.

In some embodiments, the organic ligand comprises at least one of 2,5-thiophenedicarboxylic acid (TPDC), 2-Nitro-1,4-benzenedicarboxylic acid (2-Nitro-1,4-BDC), triphenylamine, (TPA), 2,2′-bipyridine, 1,10-phenanthroline, terephthalic acid, (TPA), 2,6-Naphthalenedicarboxylic acid (NDC), 4,4′-oxybisbenzenedicarboxylic acid (OBDC), 1,3,5-benzenetricarboxylic acid (BTC), pyridine-3,5-dicarboxylic acid (PDC), 2,5-furandicarboxylic acid (FDCA), 2,6-dioxopiperazine dicarboxylic acid (DPDC), and/or 4,4′-sulfonyldibenzenedicarboxylic acid (SDBDC), and in some preferred embodiments, may be 2,5-thiophenedicarboxylic acid (TPDC) or 2-nitro-1,4-benzenedicarboxylic acid (2-Nitro-1,4-BDC).

According to embodiments of the present disclosure, the mole ratio between the Co precursor and the organic ligand used in preparing the mixed solution may range from equal to or greater than 100:90 and equal to or less than 100:110, and preferably, range from 100:95 to 100:105. Maintaining the mole ratio of the organic ligand to the Co precursor within the above ranges typically provides conditions that allow for good metal-organic framework structure formation, sufficient metal ion binding in solution, and an increased percent yield of the metal-organic framework. In addition, such conditions can increase the crystallinity of the metal-organic framework, prevent or reduce formation of by-products, and maintain an appropriate reaction rate.

According to embodiments of the present disclosure, and without being limited by mechanism, the basic additive introduced into the mixed solution may promote the bonding between the metal ion and the organic ligand in the process of forming the metal-organic framework, and can adjust the pH of the mixed solution to aid crystallization. In addition, the type and the concentration of the basic additive can be used to adjust the crystal size and shape, and the distribution of the metal-organic framework.

In some embodiments, the basic additive comprises at least one of triethylamine (TEA), dimethylamine (DMA), pyridine, trimethylamine (TMA), isopropylamine (IPA), triethanolamine (TEQA), methylamine (MA), piperidine (Pip), diethylamine (DEA), ammonia (NH₃), morpholine, methylformamide (MFA), and/or sodium hydroxide (NaOH)

The present disclosure may further include stirring one or more solution, (e.g., after the basic additive is introduced into the mixed solution containing the Co ion and the organic ligand). Stirring or otherwise uniformly mixing the Co precursor, the organic ligand, and the basic additive can increase the reaction efficiency. In some embodiments stirring or otherwise uniformly mixing a suspension may improve formation of a uniform metal-organic framework.

### Introducing of Ni Ion (S2)

According to some embodiments, the method for manufacturing the metal-organic framework of the present disclosure comprises, ‘S2’ which refers to a step for introducing a Ni precursor into the precursor solution obtained in ‘S1’ and generating a precipitate.

The Ni precursor additionally introduced according to embodiments of the present disclosure may form a structural feature in the metal-organic framework generated by the method, and which can adjust at least one electronic characteristic, and which may also provide one or both of an optical characteristic and a magnetic characteristic. In particular embodiments, since the Ni ion has high conductivity, the Ni ion (provided by the Ni precursor) shows excellent thermal and mechanical stability, and high theoretical capacity. Accordingly, some embodiment falling within the scope of the disclosure that comprise Ni ions as a component in the all-solid-state battery anode, the Ni ion may serve as a catalyst to promote an electrochemical reaction inside the battery. In particular embodiments, an initial coulomb efficiency (ICE) of the all-solid-state battery anode may be maintained higher due to higher charging/discharging characteristics.

In some embodiments, the Ni precursor comprises at least one of NiCl₂·6H₂O, NiSO₄·6H₂O, Ni(NO₃)₂·6H₂O, Ni(C₂H₃O₂)₂·4H₂O, and/or NiC₂O₄·2H₂O, and in some preferred embodiments, may include NiCl₂·6H₂O.

According to embodiments of the present disclosure, the Ni precursor is introduced after ‘S1’. Accordingly, the Co ion, which is more stable and has a larger size, reacts with the organic ligand to form a first complex or structure. Accordingly, the Co ion and the organic ligand are stably coordinate-bonded to each other, which may increase the stability of the entire structure, such that the reaction efficiency is improved. In addition, the binding between the organic ligand and Co ion may reduce steric hinderance, and reduce the dissociation of the organic ligand. Accordingly, the stability of the bond of the metal-organic framework may be improved by the method which can improve the performance and the durability of the all-solid-state battery comprising the framework.

According to embodiments of the present disclosure, the number of moles of Co precursor used may be larger than the number of moles of Ni precursors. In some embodiments, the mole ratio between Co precursors used in ‘S1’ and Ni precursors used in ‘S2’ may range from greater than 1:1 and less than or equal to 10:1, preferably, range from 4:1 to 6:1, and more preferably, range from 4.5:1 to 5.5:1. When Ni precursors are used in an excessive amount, as compared to an amount of Co precursors, the core structure including Co metal may not be sufficiently formed, and the function of each of the core structure and the surface structure may be degraded. In addition, when Co precursors are used in an excessive amount, as compared to an amount of Ni precursors, (i.e., in excess of the recited ratios) the surface part is not sufficiently formed, which can degrade the stability of the entire structure. In addition, since the characteristic on the surface of the central part is exposed to the outside, an unpredictable reaction(s) may occur. Thus, outside of the ranges described herein, the catalyst performance and the surface chemical reaction of the relevant structure may be reduced.

According to embodiments of the present disclosure, ‘S2’ may further include processing the mixed solution using ultrasonic waves after introducing the Ni precursor. In such embodiments, as the mixed solution is processed using ultrasonic waves, particles in the suspension may be reduced in size to form fine particles, which increases the reaction surface area, such that a reaction speed is accelerated. In addition, the particles may be uniformly distributed in the relevant solution in ‘S2’, and the solubility of the solution may be increased, thereby forming a more uniform metal-organic framework.

According to embodiments of the present disclosure, the process of obtaining the precipitate after introducing the Ni precursor is not limited particularly as long as a solid-phase material produced in the solution is separated. Preferably, the separation may be performed through gravitational sedimentation, centrifugation, filtration, evaporation, or the addition of precipitating reagents.

### Obtaining of Metal-Organic Framework (S3)

In embodiments the method for manufacturing the metal-organic framework according to the present disclosure comprises, ‘S3’ which refers to obtaining the metal-organic framework by cleaning and drying the precipitate obtained in ‘S2’. The metal-organic framework may have one form including a core structure including a Co ion and an organic ligand and a surface structure including a Ni ion and an organic ligand.

The cleaning process may be a process for increasing the purity of the precipitate by removing one or more impurities, and for increasing the chemical and physical stability of the precipitate. A cleaning agent used in the cleaning process is not particularly limited as long as the cleaning agent is a volatile solvent. In embodiments, the cleaning agent comprises at least one of methanol, ethanol, propanol, butanol, pentanol, hexanol, benzene, toluene, ethylbenzene, chlorobenzene, o-xylene, m-xylene, p-xylene, styrene, isopropylbenzene, normal propylbenzene, chlorotoluene, butylbenzene, dichlorobenzene, diisopropylbenzene, nitrotoluene, pentane, hexane, octane, nonane, decane, decalin, undecane, dodecane, tridecane, tetradecane, isononan, isodecane, isoundecane, isododecane, isotridecane, isotetradecane, cyclononane, cyclodecane, cycloundecane, cyclododecane, cyclotridecane, cyclotetradecane, chloroform, dichloromethane, benzyl acetate, allyl hexanoate, butylbutyrate, ethylacetate, ethylbutyrate, ethylhexanoate, ethylcinanoate, ethylheptanoate, ethylnonanoate, ethylpentanoate, isobutyl acetate, isobutyl formate, isoamyl acetate, isopropyl acetate, methylphenyl acetate, acetone, methyl ethyl ketone, methyl isobutyl ketone, diethyl ether, dimethoxyethane, dimethoxymthane, dioxane, tetrahydrofuran, anisol, crown ether, mono- and polyethylene glycol, and in some preferred embodiments comprises ethanol.

In embodiments, the drying process comprises a process for ensuring the stability by removing a residual solvent or the cleaning agent from the precipitate, and increasing the purity of the metal-organic framework. In embodiments, the drying process may be an air drying process, an oven drying process, a vacuum drying process or a microwave drying process. In some preferred embodiments, the drying process may be performed using an oven.

In some embodiments, the drying process may be performed at a temperature ranging from 70° C. to 150° C., and in preferred embodiments, at a temperature ranging from 80° C. to 110° C. When the temperature range is maintained in the above range in the drying process, the structural stability of the metal-organic framework may be increased, or at least not degraded, and the physical characteristics (e.g., the mechanical strength) may be optimized. In addition, the removal of the impurities may improve the thermal stability of the metal-organic framework.

### Metal-Organic Framework

In embodiments, the present disclosure provides the metal-organic framework including the core structure including the Co ion and the organic ligand, and the surface structure including the Ni ion and the organic ligand, and wherein the moles of Co ions are larger than the moles of Ni ions, as generally described herein.

According to embodiments of the present disclosure, the metal-organic framework may achieve the stable charging/discharging performance, capacity retention rate, and excellent initial coulombic efficiency of a battery, for example, when the metal-organic framework including both Co ion and Ni ion is used for the battery. The metal-organic framework includes the core structure including the Co ion and the organic ligand, and the surface structure including the Ni ion and the organic ligand. By forming this framework structure, the core structure including Co ions may be protected by the surface structure including Ni ions. When the metal-organic framework is applied in the all-solid-state battery, the electrochemical performance may be improved, the lifespan and the efficiency of the all-solid-state battery may be increased, and the stability of the all-solid-state battery may be improved, thereby improving the lifespan of the charging/discharging cycle of the all-solid-state battery.

In additional embodiments, in the metal-organic framework, the mole ratio of Co ions and Ni ions is maintained within a range from greater than 1:1 and less than or equal to 10:1, preferably in a range from 4:1 to 6:1, more preferably in a range from 4.5:1 to 5.5:1. Accordingly, the metal-organic framework may provide for efficient transfer of electrons in combination with lithium ions in a reduction reaction.

The organic ligand, which may be included in the metal-organic framework, has been described herein (e.g., the description about ‘S1’) and can be incorporated as a single organic ligand (i.e., a single molecular structure) or as a combination of more than one organic ligand (i.e., a mixture of molecular structures). Thus, in some embodiments, the metal organic framework can comprise more than one type of organic ligand (e.g., the Co can bind to a first organic ligand comprising a molecular structure as described herein, and the Ni ion can bind to a second organic ligand comprising the same molecular structure or a different molecular structure as the first ligand).

### Anode

The present disclosure, in some embodiments, provides an all-solid-state battery anode including the metal-organic framework.

The all-solid-state battery anode according to the present disclosure may be formed by coating an anode active material layer on a current collector.

The current collector includes various materials without particular limitation, as long as the materials have a conductivity that does not induce or create a chemical change in the all-solid-state battery. As non-limiting examples, the material may include at least one of copper, stainless steel, nickel, titanium, sintered carbon, a material comprising surface-treated copper or stainless steel with carbon, nickel, titanium, or silver, and an aluminum-cadmium alloy.

The anode active material layer, in some embodiments, may include an anode active material, a binder to fix an anode active material, a conductive material to improve electron conductivity, and a solid electrolyte. In embodiments, the anode active material may include a metal-organic framework manufactured through the method for manufacturing the metal-organic framework according to the present disclosure.

In some embodiments, the solid electrolyte, which is included in the anode active material layer, may be an inorganic solid electrolyte, such as, for example, a sulfide-based solid electrolyte, an oxide-based solid electrolyte, or a halide-based solid electrolyte, or a solid polymer electrolyte.

In some embodiments, the sulfide-based solid electrolyte may be various general sulfide-based solid electrolytes without being specifically limited. In some preferred embodiments, the sulfide-based solid electrolyte may include at least one of Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂SSiS₂—LiI, Li₂S—SiS₂—LiBr, Li₂S—SiS₂—LiCl, Li₂S—SiS₂—B₂S₃—LiI, Li2ₛ—SiS₂—P₂S₅—LiI, Li₂S—B₂S₃, Li₂S—P₂S₅—ZₘSₙ (wherein each ‘m’ and ‘n’ are positive numbers; Z can be Ge, Zn, and Ga), Li₂S—GeS₂, Li₂S—SiS₂—Li₃PO₄, Li₂S—SiS₂—LiₓMO_{y} (wherein each ‘x’ and ‘y’ are positive numbers; M can be P, S₁, Ge, B, Al, Ga, and In), and Li₁₀GeP₂S₁₂.

In some embodiments, the oxide-based solid electrolyte may be various general oxide-based solid electrolytes without being specifically limited. In some preferred embodiments, the oxide-based solid electrolyte may include at least one of Li_{1+x+y}AlₓTi₂₋ₓSi_{y}P_{3-y}O₁₂ (wherein 0<x<2, 0≤y<3), BaTiO₃, Pb(Zr, Ti) O₃ (PZT), Pb₁₋ₓLaₓZr_{1-y} Ti_{y}O₃(PLZT) (wherein 0≤x<1, 0≤y<1), PB(Mg₃Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (wherein 0<x<2, 0<y<3), LiₓAl_{y}Ti_{z} (PO₄)₃ (wherein 0<x<2, 0<y<1, 0<z<3), Li_{1+x+y}(Al, Ga)ₓ(Ti, Ge)₂₋ₓSi_{y}P_{3-y}O₁₂ (wherein 0<x<1, 0<y<1), LiₓLa_{y}TiO₃ (wherein 0<x<2, 0<y<3), Li₂O, LiOH, Li₂CO₃, LiAlO₂, Li₂O—Al₂O₃—SiO₂—P₂O₅—TiO₂—GeO₂, Li₃₊ₓLa₃M₂O₁₂ (wherein M=Te, Nb, or Zr; 0≤x≤10) and Li₇La₃Zr₂₋ₓTaₓO₁₂ (wherein 0<x<2; inclusive of Ta-doped lithium lanthanum zirconate, LLZ-Ta).

In some embodiments the solid polymer electrolyte may be one or more of any various general solid polymer electrolytes without specific limitation. In some preferred embodiments, the solid polymer electrolyte may include at least one of polyethylene oxide, poly(diallyldimethylammonium) TFSI), Cu₃N, Li₃N, LiPON, Li₃PO₄·Li₂S·SiS₂, Li₂S·GeS₂·Ga₂S₃, Li₂O·11Al₂O₃, Na₂O·11Al₂O₃, (Na, Li)₁₊ₓTi₂₋ₓAlₓ (PO₄)₃ (wherein 0.1≤x≤0.9), Li₁₊ₓHf₂₋ₓAlₓ (PO₄)₃ (wherein 0.1≤x≤0.9), Na₃Zr₂Si₂PO₁₂, Li₃Zr₂Si₂PO₁₂, Na₅ZrP₃O₁₂, Na₅TiP₃O₁₂, Na₃Fe₂P₃O₁₂, Na₄NbP₃O₁₂, Na-Silicates, Li_{0.3}La_{0.5}TiO₃, Na₅MSi₄O₂ (wherein ‘M’ is a rare-each element such as Nd, Gd, or Dy) Li₅ZrP₃O₁₂, Li₅TiP₃O₁₂, Li₃Fe₂P₃O₁₂, Li₄NbP₃O₁₂, Li₁₊ₓ(M, Al, Ga)ₓ (Ge_{1-y}Ti_{y})₂₋ₓ (PO₄)₃ (wherein x≤0.8; 0≤y≤1.0; M is Nd, Sm, Eu, Gd, Tb, Dy, Ho, Er, Tm or Yb), Li_{1+x+y}QₓTi₂₋ₓSi_{y}P_{3-y}O₁₂ (wherein 0<x≤0.4; 0<y≤0.6; Q is Al or Ga), Li₆BaLa₂Ta₂O₁₂, Li₇La₃Zr₂O₁₂, Li₅La₃Nb₂O₁₂, Li₅La₃M₂O₁₂ (wherein M is Nb or Ta) and Li₇₊ₓAₓLa₃₋ₓZr₂O₁₂ (wherein 0<x<3; A is Zn)

In embodiments, the halide-based solid electrolyte may include a Li element, an M element (wherein ‘M’ is a metal other than Li), and an X element (wherein ‘X’ is a halogen). In this case, ‘X’ may be, for example, F, Cl, Br, and I. In some embodiments comprising a halide-based solid electrolyte, the ‘X’ is preferably at least one of Br and Cl. In additional embodiments, M may be, for example, a metal element, such as Sc, Y, B, Al, Ga, and In.

In embodiments, the binder contained in the anode active material layer may include various materials without being specifically limited, as long as the various materials can fix (i.e., secure) materials of the anode active material layer. Preferably, the binder may include at least one of polytetrafluoroethylene, polyethylene oxide, polyethyleneglycol, polyacrylonitrile, polyvinylchloride, polymethylmethacrylate, polypropyleneoxide, polyphosphazene, polysiloxane, polydimethylsiloxane, polyvinylidenefluoride, polyvinylidene fluoride-hexafluoropropylene copolymer (PVDF-HFP), polyvinylidene fluoride-chlorotrifluoroethylene copolymer (PVDF-CTFE), polyvinylidene fluoride-tetrafluoroethylene copolymer (PVDF-TFE), polyvinylidenecarbonate, polyvinylpyrrolidinone, styrene-butadiene rubber, nitrile-butadiene rubber, and hydrogenated nitrile butadiene rubber.

In embodiments, a conductive material, which is able to be contained in the anode active material layer, may include various conductive materials without being specifically limited, as long as the conductive materials can improve the electrical conductivity of the anode active material layer without causing a chemical change. For example, in some embodiments the conductive material may include at least one of a carbon-based material, such as (for example) natural graphite, artificial graphite, carbon black, acetylene black, ketjen black, carbon fiber, and a carbon nano-tube; a metal-based material in the form of, for example, metal powders or metal fibers containing copper, nickel, aluminum, or silver; and a conductive polymer such as non-limiting examples of polyphenylene derivatives.

### All-Solid-State Battery

In an aspect, the present disclosure provides an all-solid-state battery including an anode.

The all-solid-state battery according to the present disclosure may include an anode, a cathode, and a solid electrolyte layer.

The solid electrolyte layer may include a solid electrolyte and a binder. The solid electrolyte and the binder have been described in the description provided herein relating to the solid electrolyte and the binder that can comprise the anode.

In embodiments, the cathode may comprise a cathode active material layer coated on a current collector, wherein the cathode active material layer may include a cathode active material, a binder, a conductive material, and a solid electrolyte. The binder, the conductive material, and the solid electrolyte have been described in the description provided herein relating to the solid electrolyte and the binder that can comprise the anode. In some embodiments, the cathode active material may include various materials without being specifically limited, as long as the materials are applied to a cathode in a typical all-solid-state battery and can reversibly absorb and discharge lithium ions.

Embodiments of the present disclosure will be described in more detail in the Embodiments and Examples that follow. However, those Embodiments and Examples are provided only for illustrative purposes, and do not limit the scope of the present disclosure or appended claims.

### Embodiment 1

(S1)₂₀ mL of dimethylformamide (DMF), 20 mL of deionized water (DI), and 20 mL of methanol (MeOH) were mixed together to prepare a solvent, and 3.33 mmol of CoCl26H₂O and 3.6 mmol of 2,5-thiophene dicarboxylic acid (TPDC) were introduced into the prepared solvent. Thereafter, 1.6 mL of triethylamine was introduced, and stirred for 5 minutes to prepare a Co precursor solution.

(S2)_{0.637} mmol of NiCl₂·6H₂O was introduced into the solution prepared in S1, sealed, and treated with an ultra-sonic wave (i.e., sonicated) for 8 hours, and the precipitate that formed was obtained by centrifugation.

(S3) after the precipitate was cleaned twice using ethanol washes, the resulting material is vacuum-dried at a temperature of 70° C. to obtain the metal-organic framework.

### Embodiment 2

For this Embodiment, the metal-organic framework was manufactured in the same manner as that of Embodiment 1, except for using 2-nitro-1,4-benzenedicarboxylic acid as the organic ligand instead of TPDC.

### Comparative Example 1

For this comparative Example, the metal-organic framework was manufactured in the same manner as that of Embodiment 1, except for using 4.00 mol of CoCl₂·6H₂O, instead of introducing NiCl₂·6H₂O in S2.

### Comparative Example 2

For this comparative Example, the metal-organic framework was manufactured in the same manner as that of Embodiment 1, except that 4.00 mol of NiCl₂·6H₂O was introduced instead of CoCl₂·6H₂O in S1, and NiCl₂·6H₂O was not introduced in S2.

### Comparative Example 3

For this comparative Example, the metal-organic framework was manufactured in the same manner as that of Embodiment 1, except that NiCl₂·6H₂O was not introduced in S2 and 3.50 mmol of CoCl₂·6H₂O and 0.50 mmol of NiCl₂·6H₂O were simultaneously introduced in S1.

### Comparative Example 4

For this comparative Example, the metal-organic framework was manufactured in the same manner as that of Embodiment 1, except that NiCl₂·6H₂O was not introduced in S2 and 3.33 mmol of CoCl₂·6H₂O and 0.637 mmol of NiCl₂·6H₂O were simultaneously introduced in S1.

### Comparative Example 5

For this comparative Example, the metal-organic framework was manufactured in the same manner as that of Embodiment 1, except that NiCl₂·6H₂O was not introduced in S2 and 3.20 mmol of CoCl₂·6H₂O and 0.80 mmol of NiCl₂·6H₂O were simultaneously introduced in S1.

### Comparative Example 6

For this comparative Example, the metal-organic framework was manufactured in the same manner as that of Embodiment 1, except for using 4.00 mmol of CoCl₂·6H₂O and 4.00 mmol of NiCl₂·6H₂O.

### Comparative Example 7

For this comparative Example, the metal-organic framework was manufactured in the same manner as that of Embodiment 1, except that NiCl₂·6H₂O was used instead of CoCl₂·6H₂O in S1, and CoCl₂·6H₂O was used instead of NiCl₂·6H₂O in S2.

### Comparative Example 8

For this comparative Example, the metal-organic framework was manufactured in the same manner as that of Embodiment 2, except that NiCl₂·6H₂O was used instead of CoCl₂·6H₂O in S1, and CoCl₂·6H₂O was used instead of NiCl₂·6H₂O was not introduced in S2.

In addition, Table 1 shows synthesizing manners (e.g., schemes) used in Embodiments 1 and 2, and Comparative examples 1 to 8, the mole ratio between Co and Ni, the introduction sequence of Co and Ni, and the organic ligand. In Table 1, a core-shell synthesizing manner is designed to introduce the Co ion and the Ni ion in difference sequences as in Embodiments 1 and 2 of the present disclosure.

TABLE 1

| | | | Ion | |
|---|---|---|---|---|
| | Synthesizing | | introducing | Organic |
| | manner | Co:Ni | sequence | ligand |
| Embodiment | Core-Shell | 5:1 | Co->Ni | TPDC |
| 1 | | | | |
| Embodiment | Core-Shell | 5:1 | Co->Ni | 2-Nitro- |
| 2 | | | | 1,4-BDC |
| Comparative | Single | — | Only Co used | TPDC |
| example 1 | container | | | |
| | synthesis | | | |
| Comparative | Single | — | Only Ni used | TPDC |
| example 2 | container | | | |
| | synthesis | | | |
| Comparative | Single | 7:1 | Simultaneously | TPDC |
| example 3 | container | | introducing | |
| | synthesis | | | |
| Comparative | Single | 5:1 | Simultaneously | TPDC |
| example 4 | container | | introducing | |
| | synthesis | | | |
| Comparative | Single | 4:1 | Simultaneously | TPDC |
| example 5 | container | | introducing | |
| | synthesis | | | |
| Comparative | Core-Shell | 1:1 | Co->Ni | TPDC |
| example 6 | | | | |
| Comparative | Core-shell | 1:5 | Ni->Co | TPDC |
| example 7 | | | | |
| Comparative | Core-shell | 1:5 | Ni->Co | 2-Nitro- |
| example 8 | | | | 1,4-BDC |

### Example 1: Electrochemical Properties of all-Solid-State Battery Anode

In the present experiment, the metal-organic frameworks manufactured according to the embodiment and the comparative example were employed as an anode active material and included in an anode active material layer. The anode active material layer was coated on the Ni current collector to manufacture the all-solid-state battery anode. In this experiment, the anode active material, the solid electrolyte, the conductive material, and the binder were included in the anode active material layer, in 45, 50, 4, and 1 wt %, respectively. Li—Ge—P—S-based Solid Ceramic Electrolyte (LGPSCB) was employed as the solid electrolyte, a Vapor Grown Carbon Nanofiber (VGCNF) was employed as a conductive material, and a Nitrile Butadiene Rubber (NBR) was employed as a binder.

Loading (mg/cm²) per electrode area, an initial capacity (charge/discharge) (mAh/g), an initial coulomb efficiency (ICE) (%), and a capacity retention rate (%) after 5 cycles of the all-solid-state battery anode in the above manner were measured as described below and in Table 2.

### Measurements

Loading per electrode area: the electrode used for battery evaluation was punched in a standardized size and prepared, and the total weight of the punched electrode was measured using a high precision scale to determine a loading value of a material per electrode area.

Initial capacity (charge/discharge): the total amount (g) of the active material was calculated by subtracting the weight of the current collector from the total weight of the punched electrode, and the actual weight of the active material was calculated by multiplying the total amount (g) of the active material, which was calculated above, by 45% which is the ratio of the active material of the organometallic structure. Thereafter, the charge/discharge capacity of the electrode was calculated based on 1 C (1000 mAg/g) using the weight of the active material.

Initial coulomb efficiency (ICE) (%): the ratio of charging capacity to discharging capacity in the first cycle was calculated.

Capacity retention rate (%): the ratio of the discharging capacity in the second cycle and the discharging capacity in the sixth cycle were calculated.

TABLE 2

| | Loading | | | |
|---|---|---|---|---|
| | per | | Initial | Capacity |
| | electrode | Initial capacity | coulomb | retention |
| | area | (charge/discharge) | efficiency | rate |
| | (mg/cm²) | (mAh/g) | (%) | (%) |
| Embodiment | 3.13 | 1643/1014 | 68 | 90 |
| 1 | | | | |
| Embodiment | 3.24 | 1623/987 | 61 | 88 |
| 2 | | | | |
| Comparative | 2.72 | 1528/920 | 60 | 95 |
| example 1 | | | | |
| Comparative | 3.17 | 1632/1163 | 71 | 61 |
| example 2 | | | | |
| Comparative | 3.15 | 1605/1010 | 59 | 77 |
| example 3 | | | | |
| Comparative | 3.12 | 1768/1078 | 60 | 75 |
| example 4 | | | | |
| Comparative | 3.33 | 1633/1030 | 63 | 78 |
| example 5 | | | | |
| Comparative | 3.1 | 1688/1098 | 64 | 78 |
| example 6 | | | | |
| Comparative | 2.62 | 1700/980 | 58 | 65 |
| example 7 | | | | |
| Comparative | 3.28 | 1682/982 | 58 | 62 |
| example 8 | | | | |

As shown in Table 2, the all-solid-state battery anodes according to Embodiment 1 and Embodiment 2, which are manufactured according to an embodiment of the present disclosure may maintain excellent coulombic efficiency and show excellent capacity retention rate.

Specifically, it may be recognized that Comparative examples 1 and 2 including the metal-organic framework prepared using only one ion are inferior to Embodiments 1 and 2, for example, in one of characteristics of the initial coulombic efficiency and the capacity retention rate. In addition, it may be recognized that Comparative examples 3 to 5 in which the Co ion and the Ni ion are simultaneously introduced instead of being separately introduced are lower in both of the initial coulombic efficiency and the capacity retention rate, compared to Embodiments 1 and 2. It may be recognized that Comparative example 6, in which the mole ratio of the Co ion and the Ni ion is outside of the ranges according to the present disclosure, are lower in the initial coulombic efficiency and the capacity retention rate, compared to Embodiments 1 and 2. Comparative examples 7 and 8, which are prepared with a modified sequence of introducing the Co ion and the Ni ion, are lower in the initial coulombic efficiency and the capacity retention rate, compared to embodiments 1 and 2.

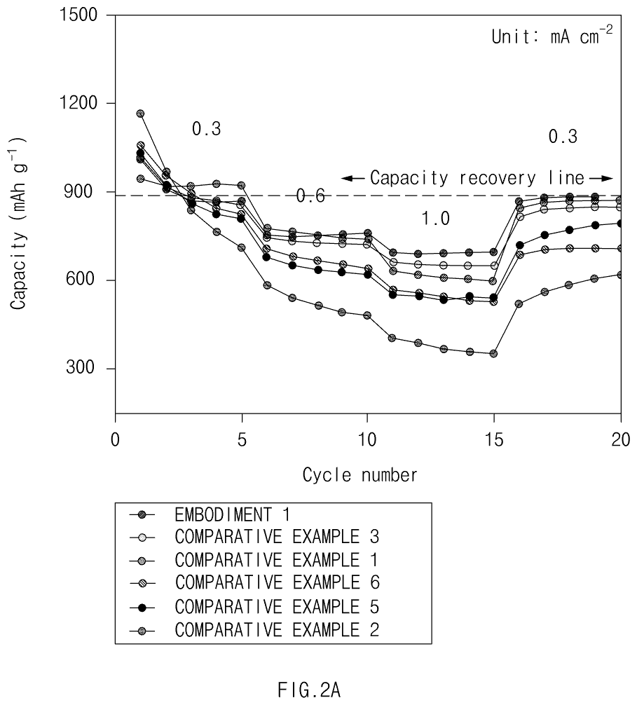

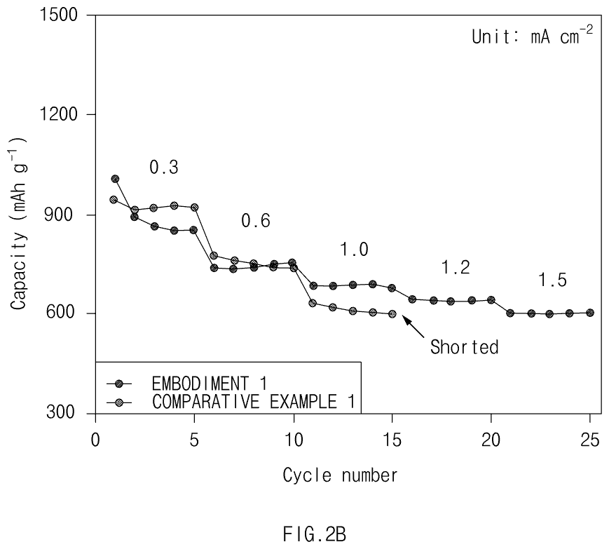

FIG. 2A shows the charging/discharging characteristic of each battery, and illustrates that an anode including the metal-organic framework according to Embodiment 1 of the present disclosure shows a higher charging/discharging capacity to operate without degradation of the performance even at the higher charging/discharging rate. In addition, FIG. 2B shows that the anode including the metal-organic framework according to Embodiment 1 of the present disclosure is stable without being shorted even under the higher current density condition, so the cell is stably driven. This contrasts from the results observed with the metal-organic framework according Comparative example 1 where a cell short occurred in the anode.

Based on the above results, it may be recognized that the all-solid-state battery anode including the metal-organic framework produced in accordance with the embodiments of the disclosure (e.g., by separately introducing the Co ion and the Ni ion while introducing the Co ion earlier than the Ni ion) achieve a higher capacity retention rate while maintaining excellent initial coulombic efficiency.

### Experimental Example 2 Characteristic of Outer Appearance and Distribution of Synthesized Metal-Organic Framework Observed

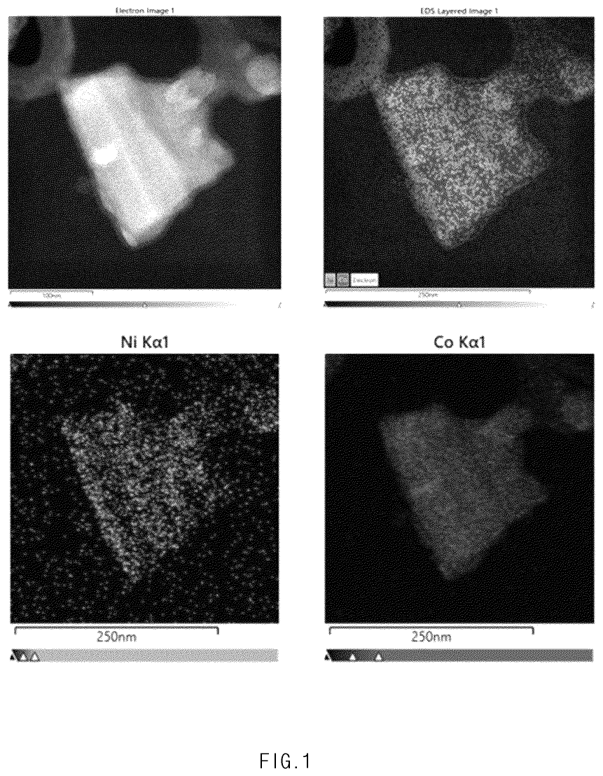

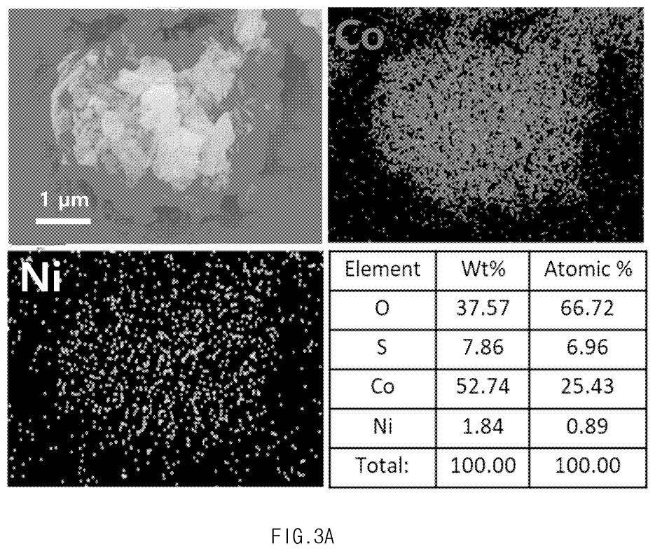

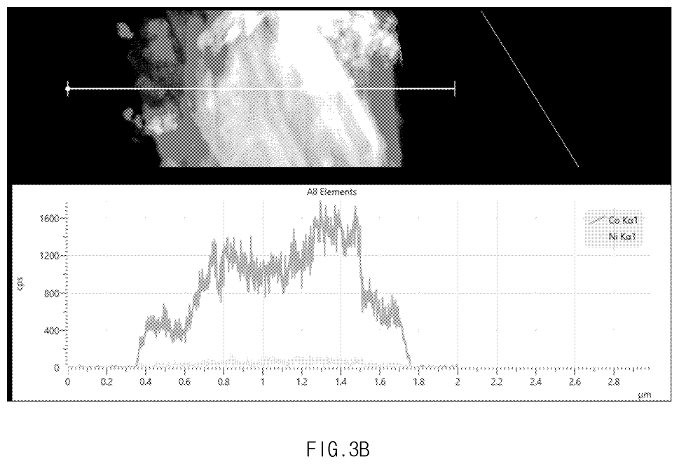

The characteristic of the outer appearance and the distribution of elements of the metal-organic framework synthesized according to Embodiment 1 is depicted in FIGS. 1, 3A, and 3B. As shown, the metal-organic framework synthesized according to Embodiment 1 of the present disclosure includes a central part (core structure) including the Co ion and the organic ligand and a surface part (surface structure) including the Ni ion and the organic ligand.

According to the methods of the present disclosure, the metal-organic framework manufactured through the methods includes the Co ion and the Ni ion and can be used for the all-solid-state battery anode. In accordance with these methods, improvements in the stability of charging/discharging performance, the capacity retention rate, and excellent coulombic efficiency may be achieved.

In addition, the disclosure provides for metal-organic frameworks manufactured through the methods of the present disclosure. The resulting metal-organic framework exhibits uniform bonding with the organic ligand, as the complex with the larger and more stable Co ion, is first synthesized, and which may minimize the dissociation resulting from any steric hinderance and contribute to the excellent electrochemical performance, when compared to metal-organic frameworks manufactured through a conventional single container synthetic method. Accordingly, the all-solid-state battery anode including the metal-organic framework produced by the methods of the disclosure show excellent initial capacity retention rate and an excellent current rate (C-rate) characteristic.

Although the present disclosure has been described with reference to the above described exemplary embodiments and the accompanying drawings, the disclosure is not limited to those embodiments. One of skill in the art will appreciate that the embodiments described above may be variously modified and altered without departing from the spirit and scope of the present disclosure and the following claims.

What is claimed is:

1. A method for manufacturing a metal-organic framework, the method comprising:
preparing a precursor solution by introducing a basic additive into a mixed solution including a Co precursor and an organic ligand (S1);
introducing an Ni precursor into the precursor solution and obtaining a precipitate (S2); and
obtaining the metal-organic framework by cleaning and drying the precipitate (S3),
wherein the number of moles of Co precursor used is larger than the number of moles of Ni precursor.

2. The method of claim 1, further comprising:
processing the precursor solution by using an ultrasonic wave after introducing the Ni precursor in the S2.

3. The method of claim 1, wherein a mole ratio between the Co precursor and the Ni precursor ranging from greater than 1:1 and less than or equal to 10:1.

4. The method of claim 1, wherein a mole ratio between the Co precursor and the organic ligand ranging from equal to or greater than 100:90 and equal to or less than 100:110.

5. The method of claim 1, wherein the organic ligand comprises 2,5-thiophenedicarboxylic acid, 2-nitro-1,4-benzenedicarboxylic acid, triphenylamine, 2,2′-bipyridine, or 1,10-phenanthroline, or combinations thereof.

6. The method of claim 1, wherein the basic additive comprises triethylamine, dimethylamine, pyridine, trimethylamine, isopropylamine, triethanolamine, or methylamine, or combinations thereof.

7. The method of claim 1, wherein the Co precursor comprises CoCl₂·6H₂O, CoSO₄·6H₂O, Co(NO₃)₂·6H₂O, Co(C₂H₃O₂)₂·4H₂O, or CoC₂O₄·2H₂O, or combinations thereof.

8. The method of claim 1, wherein the Ni precursor comprises NiCl₂·6H₂O, NiSO₄·6H₂O, Ni(NO₃)₂·6H₂O, Ni(C₂H₃O₂)₂·4H₂O, or NiC₂O₄·2H₂O, or combinations thereof.

9. The method of claim 1, wherein the metal-organic framework includes:
a core structure including a Co ion and the organic ligand; and
a surface structure including a Ni ion and the organic ligand.

10. A metal-organic framework comprising:
a core structure including a Co ion and an organic ligand; and
a surface structure including a Ni ion and an organic ligand,
wherein the metal-organic framework comprises an amount of the Co ion and an amount of the Ni ion and wherein the amount of Co ion is larger than the amount of Ni ion, in moles.

11. The metal-organic framework of claim 10, wherein the organic ligand comprises 2,5-thiophenedicarboxylic acid, 2-nitro-1,4-benzenedicarboxylic acid, triphenylamine, 2,2′-bipyridine, or 1,10-phenanthroline, or combinations thereof.

12. The metal-organic framework of claim 10, wherein a mole ratio between the Co ion and the Ni ion ranging from greater than 1:1 and less than or equal to 10:1.

13. An all-solid-state battery anode comprising the metal-organic framework of claim 10.

14. An all-solid-state battery comprising the all-solid-state battery anode of claim 13.
